(19) United States
(12) Patent Application Publication
(10) Pub. No.: US 2012/0061531 A1
(43) Pub. Date: Mar. 15, 2012

(54) Holding Structure for an Electronic Device

(76) Inventor: Chi-Pei Ho, Hsi-Chih City (TW)

(21) Appl. No.: 12/879,092

(22) Filed: Sep. 10, 2010

(51) Int. Cl. F16M 11/04; F16M 11/24

(52) U.S. Cl. 248/125.8

(57) ABSTRACT

A holding structure for an electronic device contains a vertically moving desk and a heat-venting holder, wherein the moving desk includes a plate member, and the plate member includes a stopping unit fixed on a rear side thereof and a locking mechanism disposed on a front side thereof; the heat-venting holder is putted on the plate member, and a rear side of the heat-venting holder is retained by the stopping unit, a front side of the heat-venting holder is retained by the locking mechanism so that the heat-venting holder is positioned securely.

### BACKGROUND OF THE INVENTION

1. Field of the Invention

The present invention relates to a holding structure, and more particularly to a holding structure for an electronic device that is capable of holding a holder on a plate member securely.

2. Description of the Prior Art

An electronic device, such as a notebook, is popular and portable easily because of its light weight and small size. As shown in FIG. 9, a conventional vertical moving desk 4 includes a post 41, a pneumatic bar 42 disposed on the post 41, a plate member 43 connected with a top end of the pneumatic bar 42, a support leg 44 mounted on a bottom end of the post 41, and at least one roller 45 fixed on a lower end of the support leg 44. In operation, a user controls the pneumatic bar 42 to actuate the plate member 43 to move upward or downward, and the rollers 45 of the support leg 44 is rolled to move the moving desk 4.

However, such a conventional moving desk is only used for putting a notebook thereon, and the notebook is made in a small size but having high operating speed, accordingly heat resulting from high speed operation of the notebook can not be vented effectively because the plate member contacts with the notebook, causing damage and break of the notebook easily.

In order to vent heat, a heat venting holder is fixed on the plate member of the moving desk to hold the notebook, and a suitable operating angle is capable of being adjusted, a movable panel is also provided to facilitate an operation. But due to the heat venting holder is putted on the moving desk, it is easy to slide or fall from the moving desk to break the notebook on the heat venting holder.

The present invention has arisen to mitigate and/or obviate the afore-described disadvantages.

### SUMMARY OF THE INVENTION

The primary object of the present invention is to provide a holding structure for an electronic device, of which a plate member is provided a stopping unit on the rear side thereof and a locking mechanism on the front side thereof, such that when a heat-venting holder is putted on a moving desk, the heat-venting holder is retained between the stopping unit and the locking mechanism so that the heat-venting holder is positioned securely with movement and disengagement, thus preventing a notebook from falling with the heat-venting holder.

Another object of the present invention is to provide a holding structure for an electronic device that when desiring to apply the moving desk independently, a rotary knob of the locking mechanism is loosened so that the heat-venting holder is removed form the moving desk to use the moving desk solely.

To obtain the above objectives, a holding structure for an electronic device provided by the present invention contains:

a vertically moving desk and a heat-venting holder, wherein

the moving desk includes a plate member, and the plate member includes a stopping unit fixed on a rear side thereof and a locking mechanism disposed on a front side thereof;

the heat-venting holder is putted on the plate member, and a rear side of the heat-venting holder is retained by the stopping unit, a front side of the heat-venting holder is retained by the locking mechanism so that the heat-venting holder is positioned securely.

### BRIEF DESCRIPTION OF THE DRAWINGS

FIG. 1 is a perspective view showing the assembly of a holding structure for an electronic device according to a preferred embodiment of the present invention;

FIG. 2 is a perspective view showing the exploded components of the holding structure for the electronic device according to the preferred embodiment of the present invention;

FIG. 2A is an elongated perspective view of the exploded components of a locking mechanism of the holding structure for the electronic device according to the preferred embodiment of the present invention;

FIG. 3 is a plan view showing the operation of the holding structure for the electronic device according to the preferred embodiment of the present invention;

FIG. 4 is a perspective view showing the operation of the holding structure for the electronic device according to the preferred embodiment of the present invention;

FIG. 5 is a perspective view showing a part of the assembly of the holding structure for the electronic device according to the preferred embodiment of the present invention;

FIG. 6 is another perspective view showing the operation of the holding structure for the electronic device according to the preferred embodiment of the present invention;

FIG. 7 is also another perspective view showing the operation of the holding structure for the electronic device according to the preferred embodiment of the present invention;

FIG. 8 is a plan view showing the operation of the holding structure for the electronic device according to the preferred embodiment of the present invention;

FIG. 9 is a perspective view of a conventional vertical moving desk.

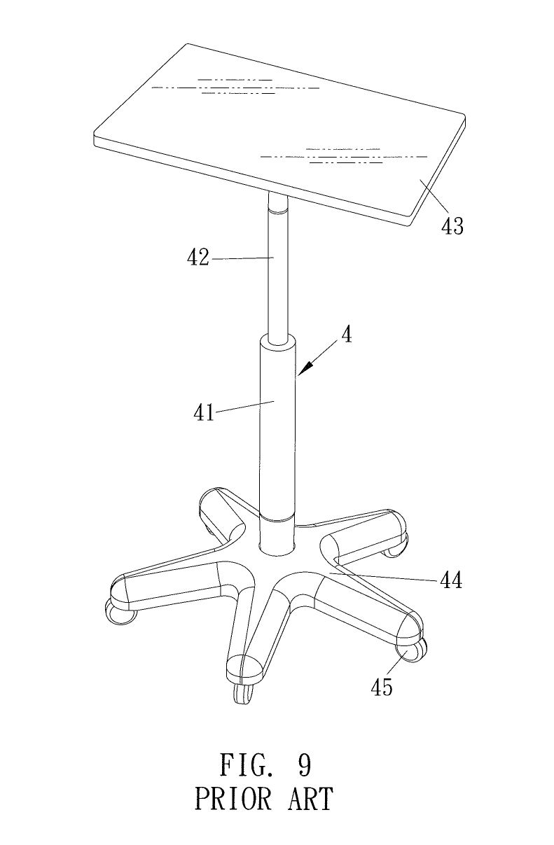

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

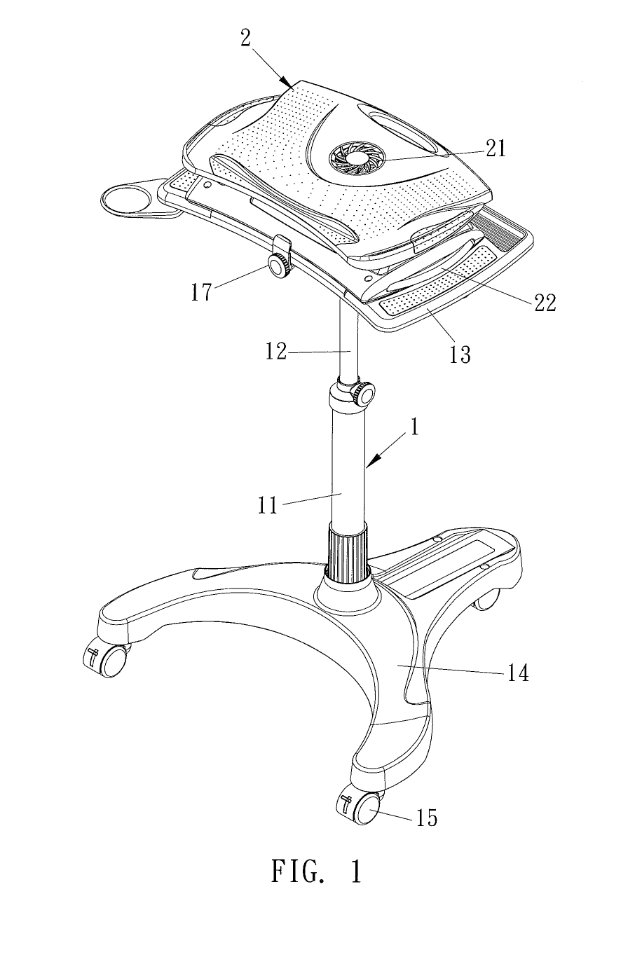

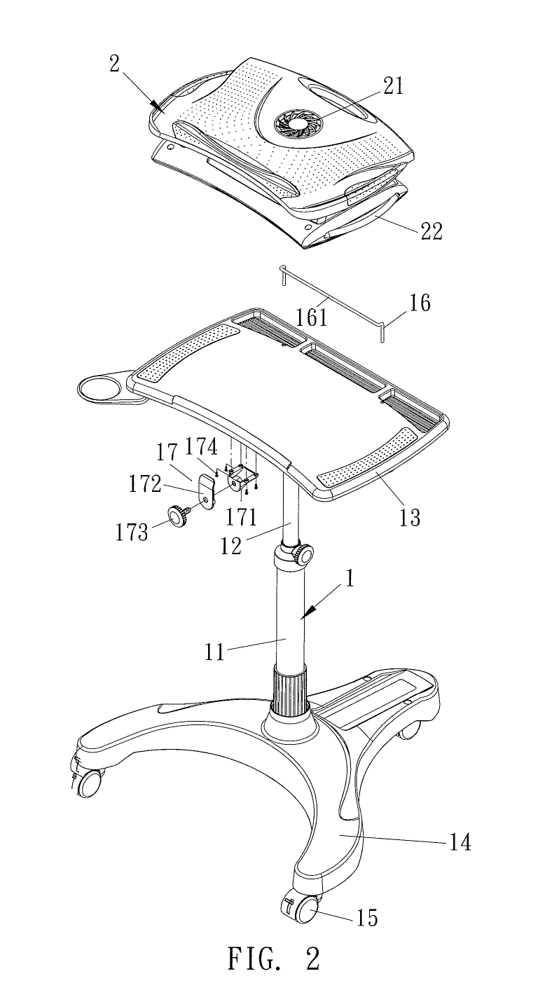

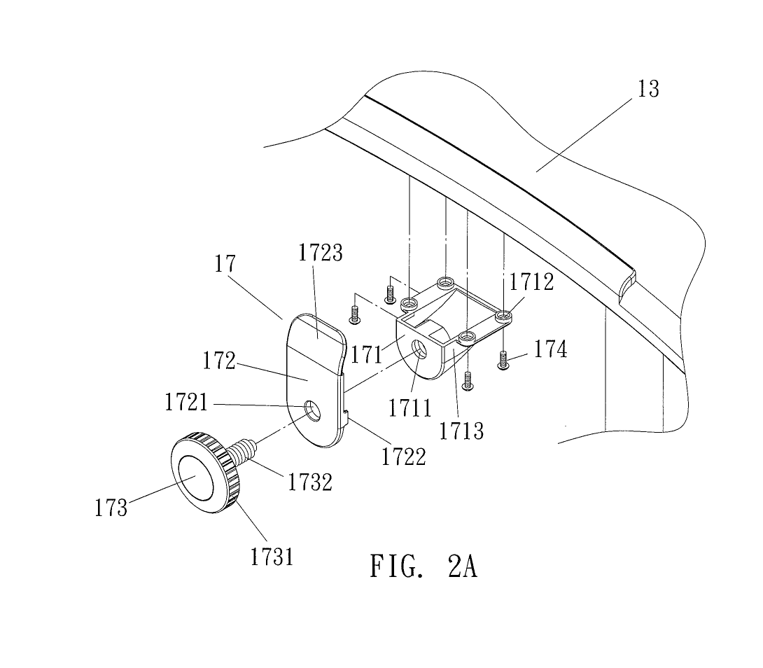

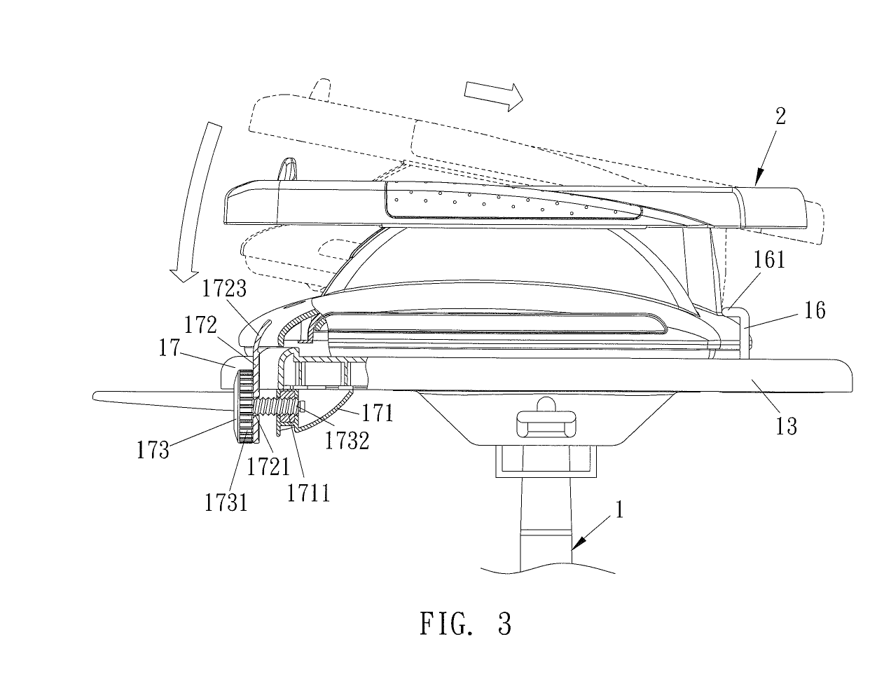

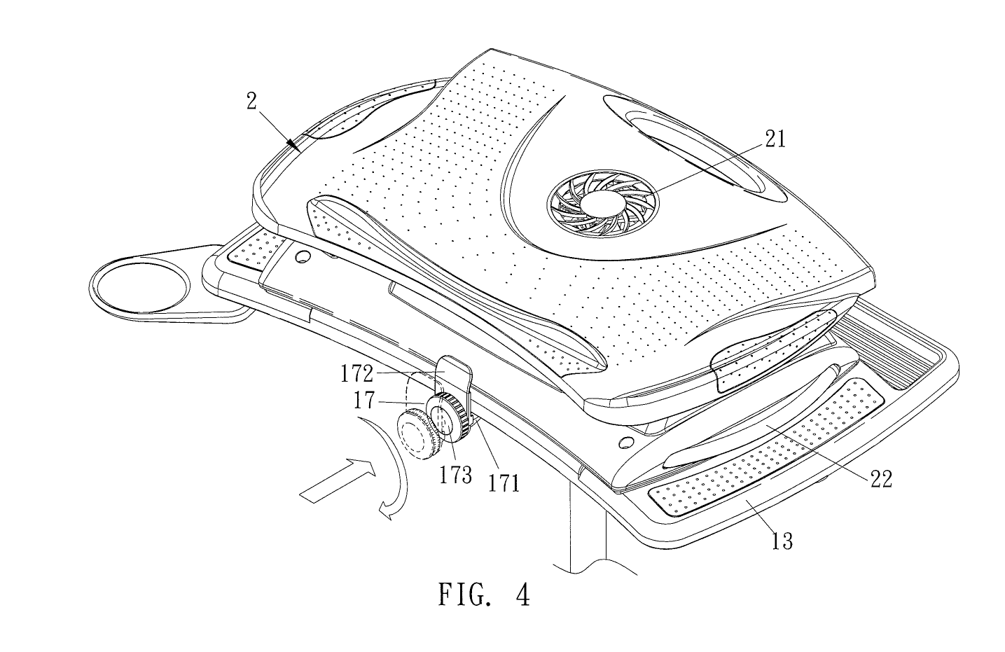

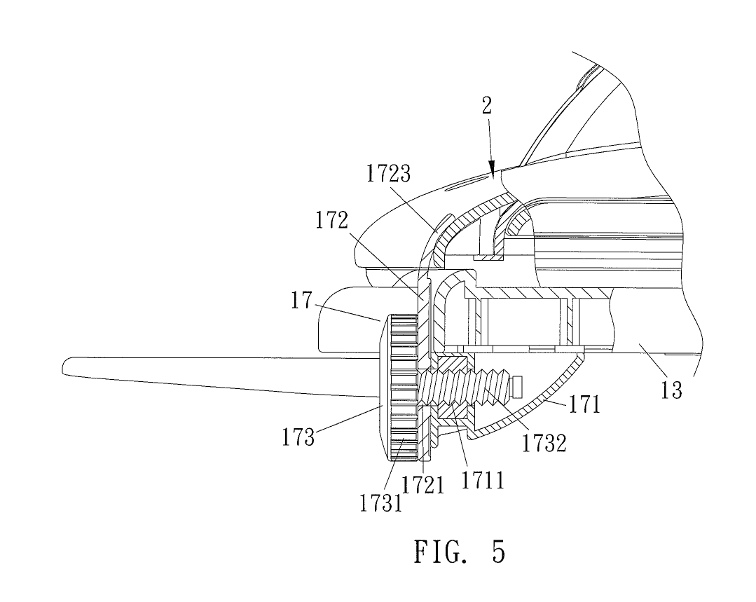

With reference to FIGS. 1-5, a holding structure for an electronic device according to a preferred embodiment of the present invention comprises a vertically moving desk 1 and a heat-venting holder 2, wherein the moving desk 1 includes a post 11, a pneumatic bar 12 connected with the post 11, a plate member 13 disposed on the pneumatic bar 12, a support leg 14 mounted on a bottom end of the post 11, and at least one roller 15 fixed on a lower side of the support leg 14, such that when a user is desired to adjust a height of the holding structure, the pneumatic bar 12 is operated to actuate the plate member 13 to move upward or downward, and the rollers 15 move the moving desk 1 rotably, the plate member 13 includes an stopping unit 16 fixed on a rear side thereof, the stopping unit 16 is formed in an inverted C shape, made of an elongated rod, and includes two end portions secured on the plate member 13 and includes a middle retaining section 161 defined between the two end portions thereof, the plate member 13 includes a locking mechanism 17 arranged on a lower rim of a front side thereof, the locking mechanism 17 is comprised of a connecting seat 171, an engaging member 172, and a rotary knob 173, and the connecting seat 171 includes a hole 1711 disposed on a front side thereof, each two bores 1712 and two positioning planes 1713 mounted on two sides of an upper ends thereof respectively, and each bore 1712 is used to insert a screwing element 174 used to lock the locking mechanism 17 on a bottom end of the plate member 13, the engaging member 172 includes a through aperture 1721 fixed on a central portion of a lower side thereof, two fixing tabs 1722 extending from two peripheral sides thereof individually, an arcuate restricting extension 1723 arranged on an upper side surface thereof, the rotary knob 173 includes a disk 1731 and a screw stem 1732 extending from a central portion of the disk 1731, and the heat-venting holder 2 includes a fan 21 and a movable panel 22. The heat-venting holder 2 is putted on the plate member 13 of the moving desk 1 at a suitable tilted angle so that a rear side of the heat-venting holder 2 is retained by the stopping unit 16, and the screw stem 1732 of the rotary knob 173 of the locking mechanism 17 is inserted through the through aperture 1721 of the engaging member 172, the rotary knob 173 is rotated by manually rotating the disk 1731 so that the screw stem 1732 of the rotary knob 173 is screwed with the hole 1711 of the connecting seat 171 to actuate the engaging member 172 to move toward the plate member 13, and the fixing tabs 1722 of the engaging member 172 contact with the positioning planes 1713 of the connecting seat 171 to limit the rotary knob 173 without movement, such that the arcuate restricting extension 1723 of the engaging member 172 retains a front side of the heat-venting holder 2 so that the heat-venting holder 2 is retained by the stopping unit 16 and the locking mechanism 17 without movement and disengagement.

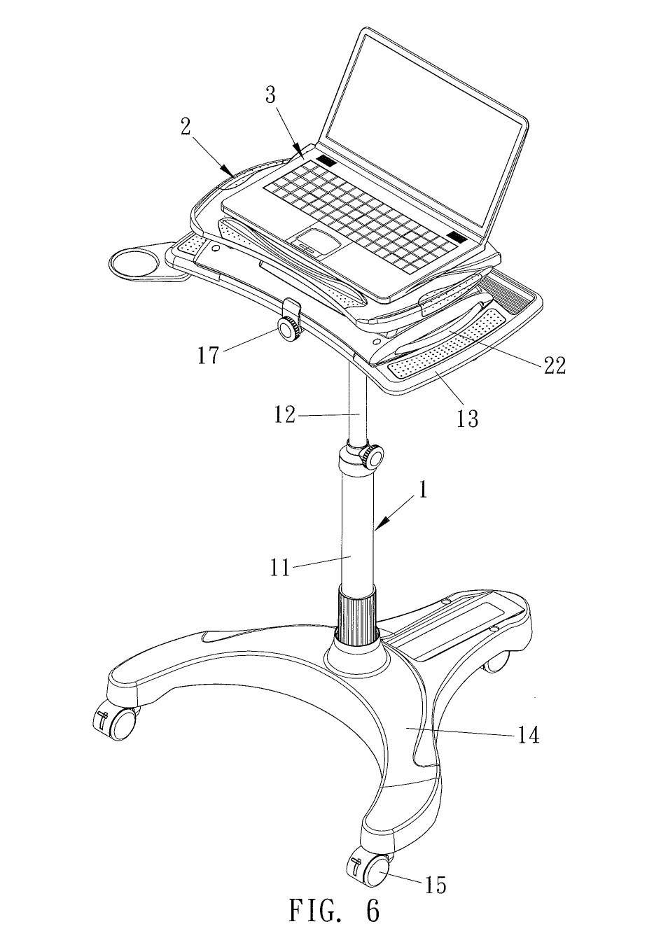

Referring to FIG. 6, when the heat-venting holder 2 holds a notebook 3, the fan 21 of the heat-venting holder 2 is used to vent heat, the heat-venting holder 2 is adjusted toward a suitable operating angle, and the movable panel 22 of the heat-venting holder 2 is served to operate the notebook 3 conveniently.

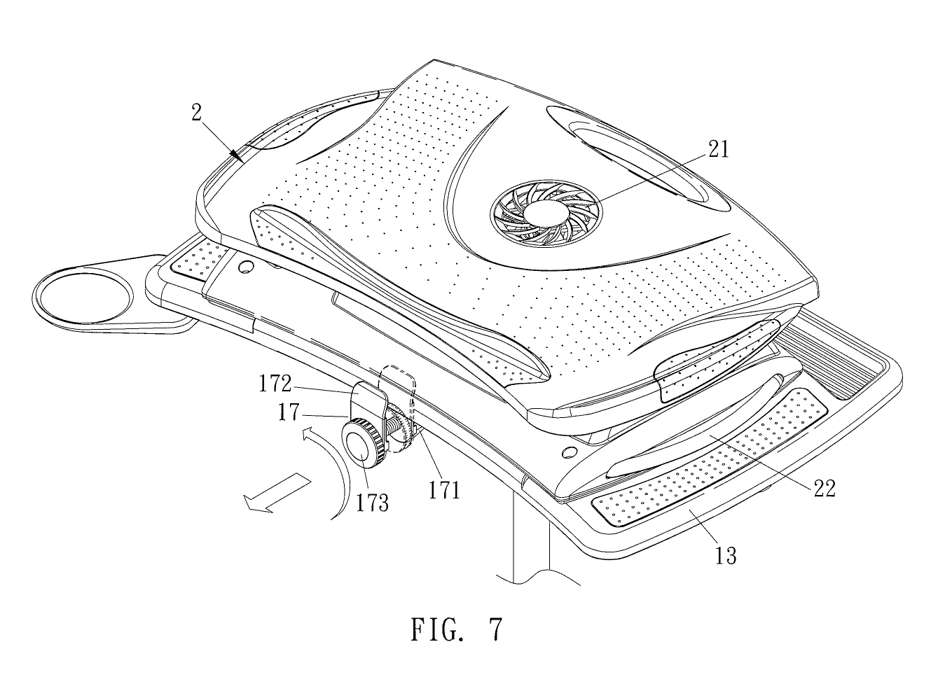

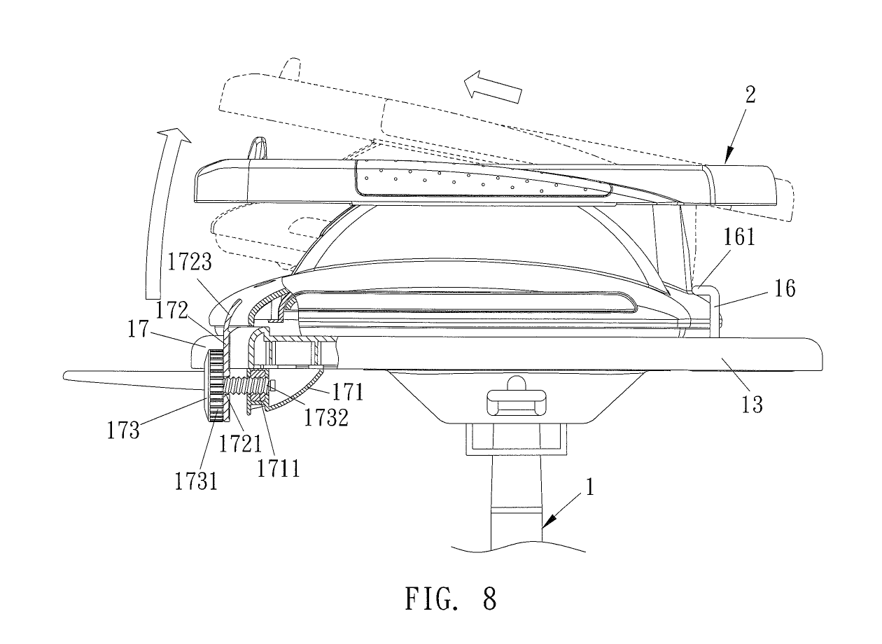

With reference to FIGS. 7 and 8, when the user intends to use the moving desk 1 independently, the disk 1731 of the rotary knob 173 is rotated adversely so that the screw stem 1732 of the rotary knob 173 is loosened from the hole 1711 of the connecting seat 171, and the arcuate restricting extension 1723 of the engaging member 172 disengages from the front side of the heat-venting holder 2 so that the heat-venting holder 2 is removed form the plate member 13 of the vertically moving desk 1, thereby enabling to use the vertically moving desk 1 independently.

Moreover, when the heat-venting holder 2 is removed from the plate member 13 of the vertically moving desk 1, the screw stem 1732 of the rotary knob 173 is loosened from the hole 1711 of the connecting seat 171 and then is moved toward a suitable position so that the fixing tabs 1722 of the engaging member 172 disengage from the positioning planes 1713 of the connecting seat 171 completely, and the arcuate restricting extension 1723 of the engaging member 172 is rotated downward to prevent from any interruption.

Thereby, the holding structure for the electronic device of the prevent invention has the following advantages:

1. The plate member 13 is provided the stopping unit 16 on the rear side thereof, and the plate member 13 is provided the locking mechanism 17 on the front side thereof, such that when the heat-venting holder 2 is putted on the plate member 13, the heat-venting holder 2 is retained between the stopping unit 16 and the locking mechanism 17 so that the heat-venting holder 2 is positioned securely with movement and disengagement, thus preventing the notebook 3 from falling with the heat-venting holder 2.

2. When desiring to apply the moving desk 1 independently, the rotary knob 173 of the locking mechanism 17 is loosened so that the heat-venting holder 2 is removed form the moving desk 1 to use the moving desk 1 solely.

While we have shown and described various embodiments in accordance with the present invention, it is clear to those skilled in the art that further embodiments may be made without departing from the scope of the present invention.

What is claimed is:

1. An holding structure for an electronic device comprising:
a vertically moving desk and a heat-venting holder, wherein
the moving desk includes a plate member, and the plate member includes a stopping unit fixed on a rear side thereof and a locking mechanism disposed on a front side thereof;
the heat-venting holder is putted on the plate member, and a rear side of the heat-venting holder is retained by the stopping unit, a front side of the heat-venting holder is retained by the locking mechanism so that the heat-venting holder is positioned securely.

2. The holding structure for the electronic device as claimed in claim 1, wherein the moving desk includes a post, a pneumatic bar connected with the post, the plate member disposed on the pneumatic bar, a support leg mounted on a bottom end of the post, and at least one roller fixed on a lower side of the support leg.

3. The holding structure for the electronic device as claimed in claim 1, wherein the stopping unit is formed in an inverted C shape, includes two end portions secured on the plate member and includes a middle retaining section defined between the two end portions thereof.

4. The holding structure for the electronic device as claimed in claim 1, wherein the locking mechanism is comprised of a connecting seat, an engaging member, and a rotary knob, and the connecting seat includes a hole disposed on a front side thereof, each two bores mounted on two sides of an upper ends thereof respectively, and each bore is used to insert a screwing element used to lock the locking mechanism on a bottom end of the plate member, the engaging member includes a through aperture fixed on a central portion of a lower side thereof, an arcuate restricting extension arranged on an upper side surface thereof, the rotary knob includes a disk and a screw stem extending from a central portion of the disk so that the screw stem of the rotary knob is screwed with the hole of the connecting seat through the through aperture of the engaging member.

5. The holding structure for the electronic device as claimed in claim 4, wherein the connecting seat includes two positioning planes mounted on the two sides of the upper ends thereof respectively, and the engaging member includes two fixing tabs extending from two peripheral sides thereof individually.
